(19) United States
(12) Patent Application Publication
(10) Pub. No.: US 2012/0110075 A1
(43) Pub. Date: May 3, 2012

(54) INFORMATION PROCESSING APPARATUS, INFORMATION PROCESSING METHOD AND PROGRAM

(76) Inventors: Matthew Dickinson FORREST, JR., Kanagawa (JP); Lukas Golyszny, Wolfsburg (DE)

(21) Appl. No.: 13/157,187

(22) Filed: Jun. 9, 2011

(30) Foreign Application Priority Data
Jun. 18, 2010 (JP) P2010-139936

(51) Int. Cl. G06F 15/16

(52) U.S. Cl. 709/204

(57) ABSTRACT

There is provided an information processing apparatus including a judgment unit that, upon receiving the message indicating that the first terminal apparatus and the second terminal apparatus have mutually communicated, judges whether there is any common application between the one or the plurality of applications associated with the first terminal apparatus and the one or the plurality of applications associated with the second terminal apparatus, and a first transmitting unit that, when the common application is present, transmits the message indicating that the first user and the second user make friend registration with the common application to one or a plurality of corresponding application server apparatuses.

### BACKGROUND

The present disclosure relates to an information processing apparatus, an information processing method, and a program.

A social networking service (hereinafter, also referred to as an SNS) provided on the Internet provides a service whereby a social network is constructed among a plurality of users sharing a common hobby, activity or the like. The SNS is a network service realized by using server apparatuses and terminal apparatuses and is realized by, for example, a network application. Each SNS has individual features and different purposes and thus, one user may have registered with a plurality of SNSs as a user.

Japanese Patent Application Laid-Open No. 2007-287131 discloses a technology relating to the SNS and discloses a technology to incorporate other services than the SNS in accordance with the user.

### SUMMARY

The SNS has a function to allow a user to register other users as “Friends”. Accordingly, the user can transmit/receive messages to/from other users registered as “Friends” or release the user's profile.

Incidentally, to register other users as “Friends”, it is necessary for the user to have user names of other users in the SNS transmitted via paper, mail or the like to obtain approval of the friend application from other users. One user may use a different user name for each SNS and if the user names of a plurality of SNSs should be made known to other users, it is necessary to enumerate a plurality of user names. Furthermore, if the user wants to make a friend application to a plurality of SNSs, it is necessary for the user to make a friend application one by one by accessing each SNS.

Japanese Patent Application Laid-Open No. 2007-287131 discloses a procedure for making a friend application, but as in the past, it is necessary for the user to manually input the name of a user to be registered as a friend via a screen of the SNS.

In light of the foregoing, it is desirable to provide a novel and improved information processing apparatus, information processing method, and program allowing each user to easily make friend registration without going through, when an application registered among users in common is present, processing provided by the application.

According to an embodiment of the present disclosure, there is provided an information processing apparatus including a receiving unit that receives information about one or a plurality of applications from each of a first terminal apparatus associated with a first user and a second terminal apparatus associated with a second user and receives a message indicating that mutual communication has been performed from the first terminal apparatus and the second terminal apparatus after the first terminal apparatus and the second terminal apparatus mutually communicate, a judgment unit that, upon receiving the message indicating that the first terminal apparatus and the second terminal apparatus have mutually communicated, judges whether there is any common application between the one or the plurality of applications associated with the first terminal apparatus and the one or the plurality of applications associated with the second terminal apparatus, and a first transmitting unit that, when the common application is present, transmits the message indicating that the first user and the second user make friend registration with the common application to one or a plurality of corresponding application server apparatuses.

When the judgment unit judges that the application that is not common is present, the first transmitting unit may transmit information about the application that is not common to the first terminal apparatus or the second terminal apparatus that is not associated with the application that is not common.

The information about the one or the plurality of applications received from the first terminal apparatus may be associated with first virtual subject information associated with the first terminal apparatus and the information about the one or the plurality of applications received from the second terminal apparatus may be associated with second virtual subject information associated with the second terminal apparatus. And the judgment unit may judge whether there is any common application between the one or the plurality of applications associated with the first virtual subject information and the one or the plurality of applications associated with the second virtual subject information.

The information processing apparatus may further include a second transmitting unit that, upon receiving the message indicating that the first terminal apparatus and the second terminal apparatus have mutually communicated, transmits data registered by the first user in advance to the second terminal apparatus.

The application may be a social networking service.

According to another embodiment of the present disclosure, there is provided an information processing method including receiving information about one or a plurality of applications from each of a first terminal apparatus associated with a first user and a second terminal apparatus associated with a second user and receiving a message indicating that mutual communication has been performed from the first terminal apparatus and the second terminal apparatus after the first terminal apparatus and the second terminal apparatus mutually communicate, upon receiving the message indicating that the first terminal apparatus and the second terminal apparatus have mutually communicated, judging whether there is any common application between the one or the plurality of applications associated with the first terminal apparatus and the one or the plurality of applications associated with the second terminal apparatus, and when the common application is present, transmitting the message indicating that the first user and the second user make friend registration with the common application to one or a plurality of corresponding application server apparatuses.

According to another embodiment of the present disclosure, there is provided a program causing a computer to execute receiving information about one or a plurality of applications from each of a first terminal apparatus associated with a first user and a second terminal apparatus associated with a second user and receiving a message indicating that mutual communication has been performed from the first terminal apparatus and the second terminal apparatus after the first terminal apparatus and the second terminal apparatus mutually communicate, upon receiving the message indicating that the first terminal apparatus and the second terminal apparatus have mutually communicated, judging whether there is any common application between the one or the plurality of applications associated with the first terminal apparatus and the one or the plurality of applications associated with the second terminal apparatus, and when the common application is present, transmitting the message indicating that the first user and the second user make friend registration with the common application to one or a plurality of corresponding application server apparatuses.

According to the embodiment of the present disclosure described above, each user can easily make friend registration without going through, when an application common among users is present, processing provided by the application.

### BRIEF DESCRIPTION OF THE DRAWINGS

FIG. 1 is an explanatory diagram showing a system according to an embodiment of the present disclosure;

FIG. 2 is a block diagram showing a management server 100 according to the embodiment;

FIG. 3 is a block diagram showing a terminal 200 according to the embodiment;

FIG. 4 is a flowchart showing an operation of the system according to the embodiment;

FIG. 5 is an explanatory diagram showing an account creation/login screen;

FIG. 6 is an explanatory diagram showing a device registration screen;

FIG. 7 is an explanatory diagram showing an identity creation screen;

FIG. 8 is an explanatory diagram showing an identity registration confirmation screen;

FIG. 9 is an explanatory diagram showing an identity management screen;

FIG. 10 is an explanatory diagram showing an identity selection screen during handshake;

FIG. 11 is an explanatory diagram showing an SNS confirmation screen of an identity during handshake;

FIG. 12 is an explanatory diagram showing an SNS setting screen during handshake;

FIG. 13 is an explanatory diagram showing the SNS confirmation screen of the identity during handshake;

FIG. 14 is an explanatory diagram showing the SNS confirmation screen of the identity during handshake;

FIG. 15 is an explanatory diagram showing an execution confirmation screen during handshake;

FIG. 16 is an explanatory diagram showing an SNS matching confirmation screen during handshake;

FIG. 17 is an explanatory diagram showing the SNS matching confirmation screen during handshake;

FIG. 18 is an explanatory diagram showing a present offering screen during handshake;

FIG. 19 is an explanatory diagram showing a playback screen of a file offered as a present during handshake; and

FIG. 20 is an explanatory diagram showing an SNS personal information confirmation screen.

### DETAILED DESCRIPTION OF THE EMBODIMENT

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

The description will be provided in the order shown below:

1. Configuration of an embodiment

2. Operation of an embodiment

### 1. Configuration of an Embodiment

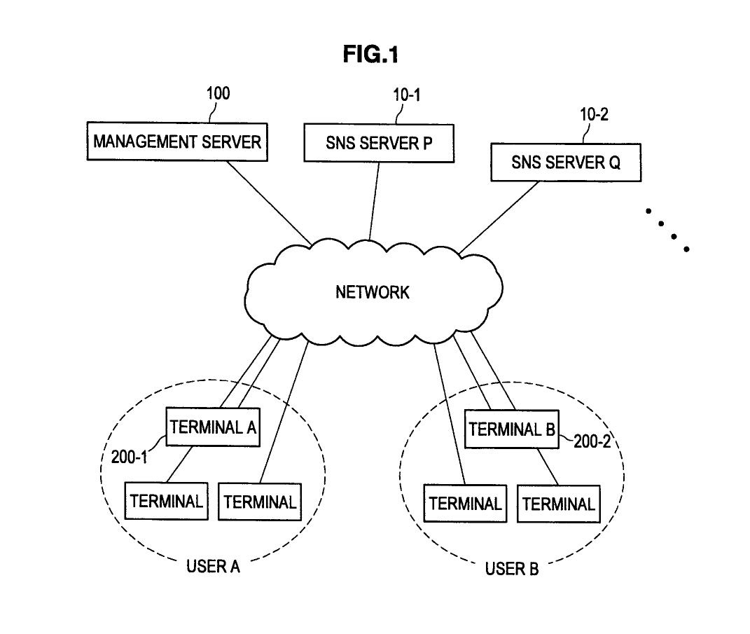

First, the configuration of a system according to an embodiment of the present disclosure will be described with reference to FIG. 1. FIG. 1 is an explanatory diagram showing a system according to the present embodiment.

The system according to the present embodiment includes a management server 100 connected to a network, a plurality of terminals (a terminal A200-1, a terminal B200-2 and the like), and a plurality of SNS servers (an SNS server P10-1, an SNS server Q10-2 and the like). In the system according to the present embodiment, if, after users perform proximity communication using terminals 200, there is a common SNS (social networking service), friend registration provided by the SNS is automatically made for both users. If there is an SNS with which only one user is registered, the present system automatically makes a recommendation to the other user for the SNS. The SNS is a network service realized by using an SNS server 10 and the terminals 200 and is realized by, for example, a network application (a server application and a client application).

Bringing the terminal 200 of the user closer to the terminal 200 of another user to cause proximity communication between the terminals 200 of both users to receive the present service described above is called a “handshake”.

The SNS server 10 provides SNSs to users registered via a network. The SNS server 10 provides a service whereby a social network is constructed among a plurality of users sharing a common hobby, activity or the like. Services provided by a plurality of the SNS servers P10-1, Q10-2 have individual features and different purposes. Thus, the user selects one or a plurality of SNSs suiting the user's purpose, convenience or the like from the plurality of SNSs and registers with the selected SNS as a user.

The management server 100 is a server apparatus that provides a service realized by a system according to the present embodiment via a network. The service provided by the management server 100 is provided to registered users.

The terminal 200 is an information processing apparatus that receives offering of a service realized by the system according to the present embodiment via a network. The terminal 200 is, for example, a personal computer, digital still camera, camcorder, mobile phone, TV, game machine or the like. The terminal 200 may also be a card associated with a specific device. If a card associated with, for example, a TV is used, a device like a TV that is hard to move can be caused to perform proximity communication with the other terminal 200. Each user may have a plurality of the terminals 200. As shown, for example, in FIG. 1, a user A has a plurality of terminals, in addition to the terminal A200-1 and a user B has a plurality of terminals, in addition to the terminal 200-2. User registration in the present embodiment is made in units of users and the plurality of terminals 200 is registered with each user.

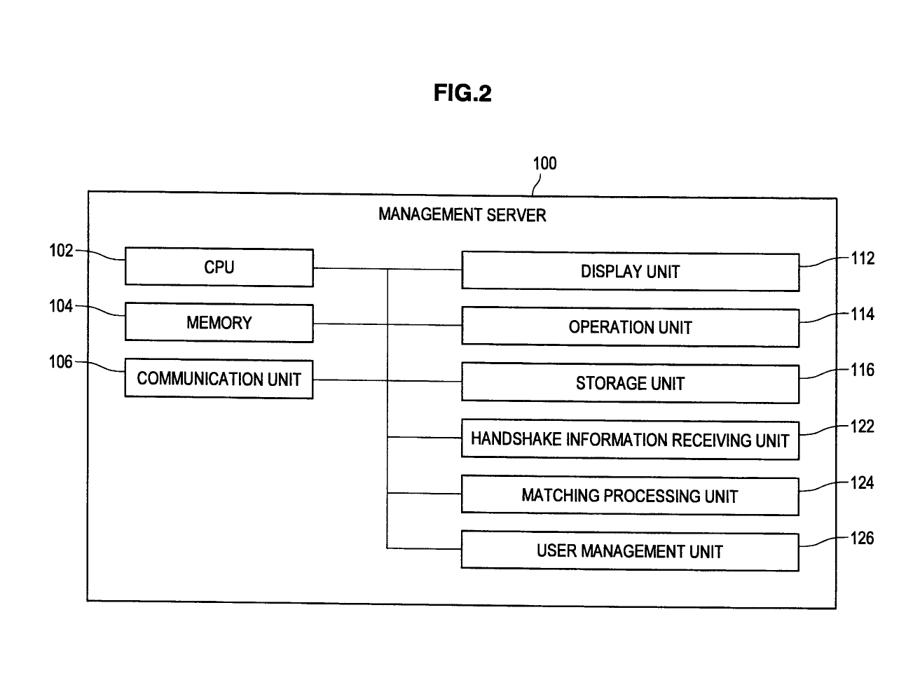

Next, the management server 100 according to the present embodiment will be described with reference to FIG. 2. FIG. 2 is a block diagram showing the management server 100 according to the present embodiment.

The management server 100 includes, for example, a CPU 102, a memory 104, a communication unit 106, a display unit 112, an operation unit 114, a storage unit 116, a handshake information receiving unit 122, a matching processing unit 124, and a user management unit 126.

The CPU 102 controls each structural element of the management server 100 and performs arithmetic processing based on a program.

The memory 104 stores a program processed by the CPU 102 or temporarily records various kinds of data.

The communication unit 106 transmits/receives data to/from the SNS server 10 or the terminals 200 via a network. Communication by the communication unit 106 may be either wire communication or wireless communication. The communication unit 106 is an example of the receiving unit and receives the user name, password, e-mail address, and information about SNS from the terminal 200. The communication unit 106 is also an example of a second transmitting unit and transmits data (such as an image file and sound file) registered by the user in advance to the terminals 200.

The display unit 112 is, for example, a liquid crystal display and displays, based on a display signal, information necessary to control the management server 100 or information necessary to manage the present service.

The operation unit 114 is, for example, a keyboard or mouse and receives input from the administrator who manages the management server 100 to generate an operation signal. The operation unit 114 sends the generated operation signal to the CPU 102 and the like.

The storage unit 116 is, for example, an HDD and records information about the user received from the terminal 200 and data (such as an image file and sound file) registered by the user in advance.

The handshake information receiving unit 122 is an example of the receiving unit and receives handshake information transmitted by the terminals 200 after the terminals 200 perform proximity communication with each other. The handshake information is, for example, the user name of the user of the terminal 200, the user name of other user of the terminal 200 with whom proximity communication has been performed, and information (proximity information) indicating that proximity communication has been performed.

The matching processing unit 124 is an example of a judgment unit and checks, based on the handshake information received from the terminal 200, whether there is any SNS with which the users having the terminals 200 that have performed proximity communication are registered in common. If there is such an SNS, the matching processing unit 124 is an example of a first transmitting unit and transmits information of friend registration, the user name of each user in the SNS and the like to the SNS server 10 so that the users can register with the SNS as friends. The SNS server 10 that has received the information from the management server 100 performs processing so that the users are registered as friends.

The matching processing unit 124 is an example of the first transmitting unit and, if there is an SNS with which only one of the users is registered, makes a recommendation to the other user of registration with the SNS with which the one user is registered. For example, the matching processing unit 124 causes an identity management screen managed by each user to display the SNS recommended by other users.

The user management unit 126 manages information about users registered with a service provided by a system according to the present embodiment. The information about users includes an identity created by the user for each user, the user name in the SNS associated with the identity, information about the terminal 200 registered by the user, and a history of handshake (for example, the other user, time, and location).

The identity is a personality (virtual subject information) in the present service formed to perform a handshake. A plurality of identities can be formed by each user and the SNS to be associated with can be made different in accordance with the other user with whom a handshake is performed. For example, a business identity and a private identity may be formed so that the business identity is associated with an SNS useful for business and the private identity is associated with an SNS concerning hobbies. A multitude of identities may also be formed so that such identities are used for different purposes such as the home, friends from school days, and friends from adult life.

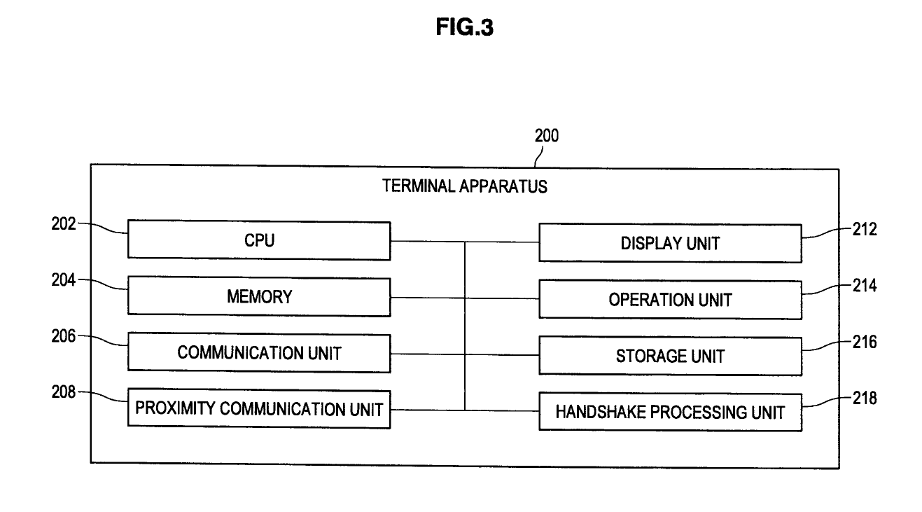

Next, the terminal 200 according to the present embodiment will be described with reference to FIG. 3. FIG. 3 is a block diagram showing the terminal 200 according to the present embodiment.

The terminal 200 includes, for example, a CPU 202, a memory 204, a communication unit 206, a proximity communication unit 208, a display unit 212, an operation unit 214, a storage unit 216, and a handshake processing unit 218.

The CPU 202 controls each structural element of the terminal 200 and performs arithmetic processing based on a program.

The memory 204 stores a program processed by the CPU 202 or temporarily records various kinds of data.

The communication unit 206 transmits/receives data to/from the SNS server 10 or the management server 100 via a network. Communication by the communication unit 206 may be either wire communication or wireless communication.

The proximity communication unit 208 transmits/receives data to/from the proximity communication unit mounted on the other terminal 200. Proximity communication by the proximity communication unit 208 includes, for example, wireless communication by a non-contact IC card (for example, FeliCa (registered trademark)) having a nonvolatile memory and a wireless communication chip and wireless communication (for example, TransferJet (registered trademark)) using a coupler using an induction field.

The display unit 212 is, for example, a liquid crystal display and displays, based on a display signal, information necessary to control the terminal 200, information necessary to manage the present service, or information about the SNS by the SNS server 10.

The operation unit 214 is, for example, a keyboard or mouse and receives input from the user using the terminal 200 to generate an operation signal. The operation unit 214 sends the generated operation signal to the CPU 202 and the like.

The storage unit 216 is, for example, an HDD and records various kinds of data such as video data and sound data.

The handshake processing unit 218 transmits information about the terminal 200, for example, the user name and ID when proximity communication is performed with the other terminal 200. The handshake processing unit 218 also receives information about the other terminal 200, for example, the user name and ID when proximity communication is performed with the other terminal 200. Then, the handshake processing unit 218 transmits the user name of the user of the terminal 200, the user name of other user of the terminal 200 with whom proximity communication has been performed, and information (proximity information) indicating that proximity communication has been performed to the management server 100 as handshake information.

### 2. Operation of an Embodiment

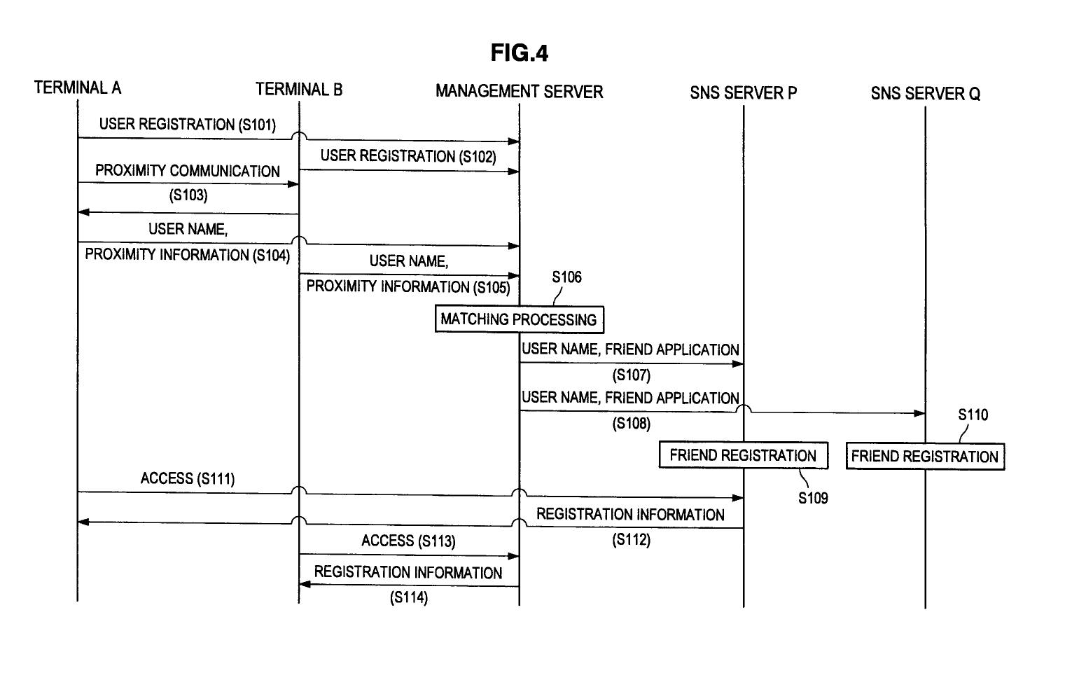

Next, the operation of a system according to the present embodiment will be described with reference to FIG. 4. FIG. 4 is a flow chart showing the operation of a system according to the present embodiment.

First, each user registers with the management server 100 as a user to receive a service provided by a system according to the present embodiment. The user can register as a user via the terminal 200. Each of the terminals 200 transmits the user name, password, e-mail address, information about the SNS and the like to the management server 100 (steps S101, S102). Then, the management server 100 registers each user as a user.

The user A and the user B bring their terminals 200 closer to each other in a state in which offering of the present service is ready to be received. Then, the terminal A200-1 of the user A and the terminal B200-2 of the user B perform proximity communication to receive offering of the present service (perform a handshake) (step S103). As a result, the terminal A200-1 and the terminal B200-2 each transmit handshake information (for example, the user name and proximity information) to the management server 100 (steps S104, S105).

The management server 100 that has received the handshake information performs matching processing (step S106). That is, the management server 100 judges whether there is any SNS common to both users. If there is a common SNS, the management server 100 transmits information indicating friend registration and the user name in the SNS of each user and the like to the SNS server 10 offering the SNS (steps S107, S108). If, for example, as shown in FIG. 4, two SNSs of the SNS provided by the SNS server P10-1 and the SNS provided by the SNS server Q10-2 are common to the user A and the user B, the management server 10 transmits the user name and the like to each of the SNS server P10-1 and the SNS server Q10-2. Each of the SNS server P10-1 and the SNS server Q10-2 performs processing so that the users are registered as friends in each SNS (steps S109, S110).

From the above, as shown in FIG. 4, if, for example, the terminal A200-1 accesses the SNS server P10-1 (step S111), the terminal A200-1 can receive registration information of the user A about the SNS (step S112). Then, when the terminal A200-1 is made to display the personal information confirmation screen of the SNS, the user can check that the other user (user B) with whom a handshake has been performed through proximity communication is registered as a friend. Though not illustrated in FIG. 4, this also applies similarly to the terminal B200-2.

If, for example, the terminal B200-2 accesses the management server 100 (step S113), the terminal B200-2 can receive registration information of the user B about the present system (step S114). Then, when the terminal B200-2 is made to display the identity management screen, the user B can check that the SNS with which the other user (user A) with whom a handshake has been performed is registered but the user B is not registered is recommended in the screen. Though not illustrated in FIG. 4, this also applies similarly to the terminal A200-1.

In step S103, when a handshake is performed, data (present data) of individual image files, sound files or like may be made mutually exchangeable. The present data is transmitted to each of the terminals 200 by the management server 100 that has verified that a handshake has been performed to provide the present data to each of the terminals 200. If the present data is made updatable by the user, incentives are offered to perform a handshake for users who have already performed a handshake each time they meet, instead of a one-off handshake. As a result, the handshake will be performed more frequently, activating the service provided by the present system.

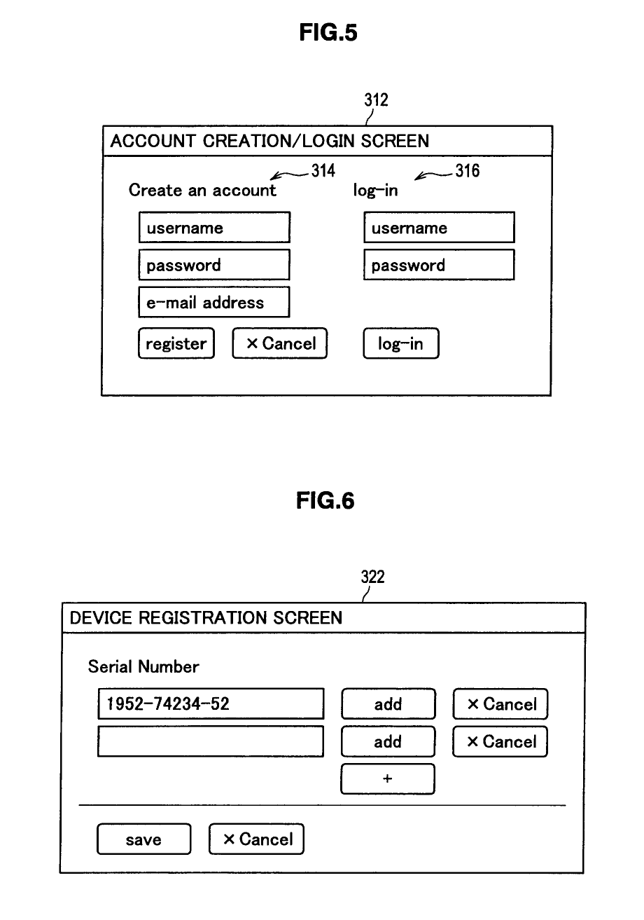

Next, user registration of the system according to the present embodiment will be described with reference to FIGS. 5 to 9.

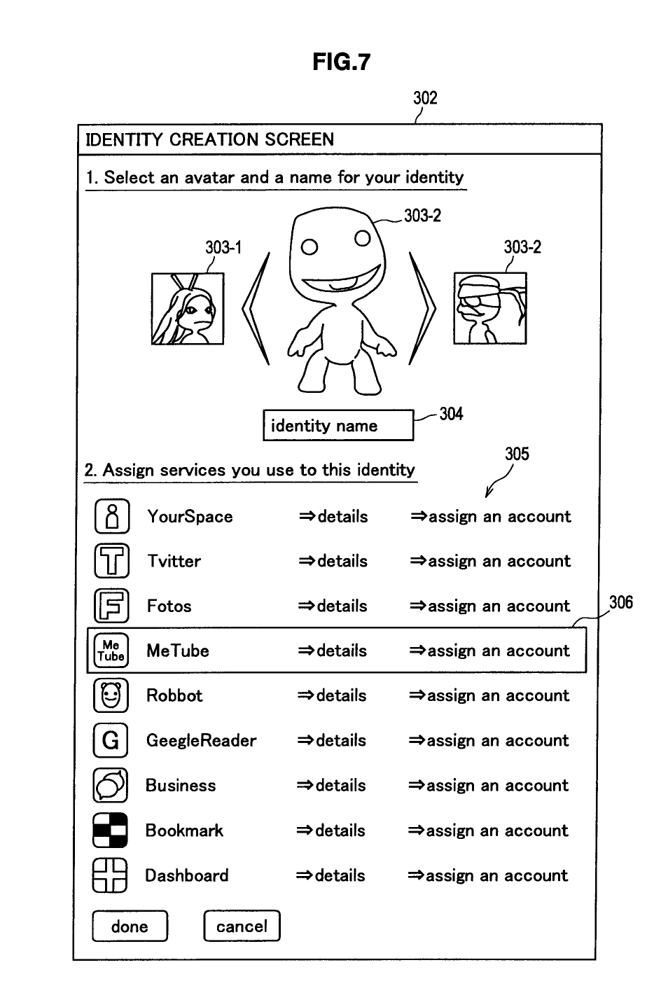

FIG. 5 is an explanatory diagram showing an account creation/login screen 312. FIG. 6 is an explanatory diagram showing a device registration screen 322. FIG. 7 is an explanatory diagram showing an identity creation screen 302. All screens are displayed in the terminal 200 owned by the user and information input into one of the screens is transmitted to the management server 100. User registration is made in units of users.

The account creation/login screen 312 shown in FIG. 5 includes an account creation field 314 and a login field 316. New user registration is made by creating an account. If the user registration is already made, the user can log in from the login field 316.

The device registration screen 322 shown in FIG. 6 includes a field to input the serial number of the terminal 200 (device). The terminal 200 owned by the user can be registered for each user by device registration. As a result, regardless of the terminal 200 used for handshake, the SNS associated with the user can be recognized so that the same service can be received.

The identity creation screen 302 shown in FIG. 7 includes avatars 303-1, 303-2, 303-3, an identity name input field 304, an SNS list 305 and the like. A plurality of identities can be formed for one user. An identity can be distinguished from other identities by using, for example, the avatar 303 and an identity name. If there is a method (for example, the ID number) capable of distinguishing each identity, the service provided by the system according to the present embodiment can be realized without using the avatar 303 or the identity name.

The user can select the SNS to be associated with the selected identity through the identity creation screen 302. The SNS list 305 displays SNSs linked to by the present service and SNSs registered by the user. Before being associated with an identity, SNSs registered by the user may explicitly be shown in the screen 302 to be distinguishable from SNSs that are not registered by the user.

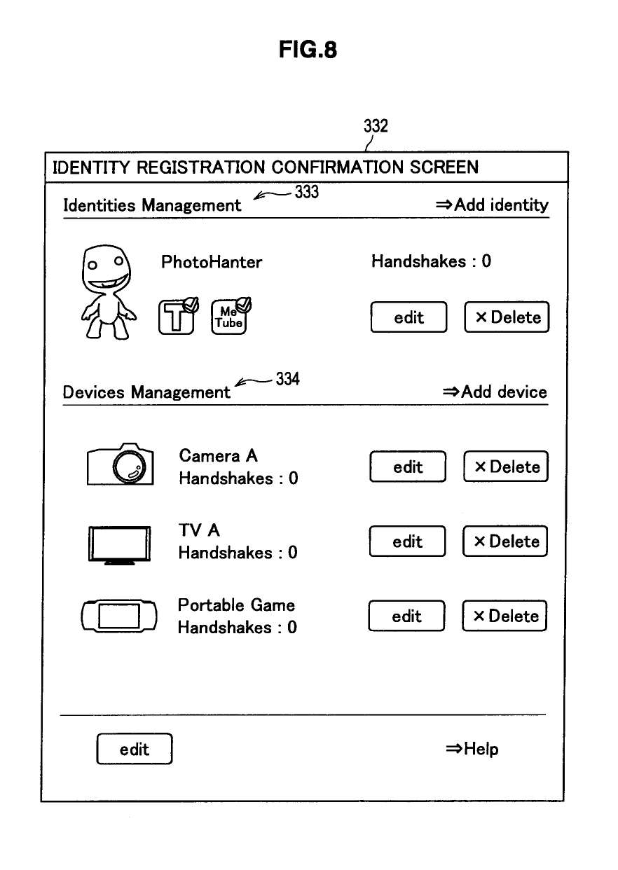

FIG. 8 is an explanatory diagram showing an identity registration confirmation screen 332. The identity registration confirmation screen 332 includes an identity management field 333, a device management field 334 and the like. Results of input in the screens shown in FIGS. 5 to 7 are displayed in the identity registration confirmation screen 332. Then, the user can change registration content of the identity or change registration content of the device via the identity registration confirmation screen 332.

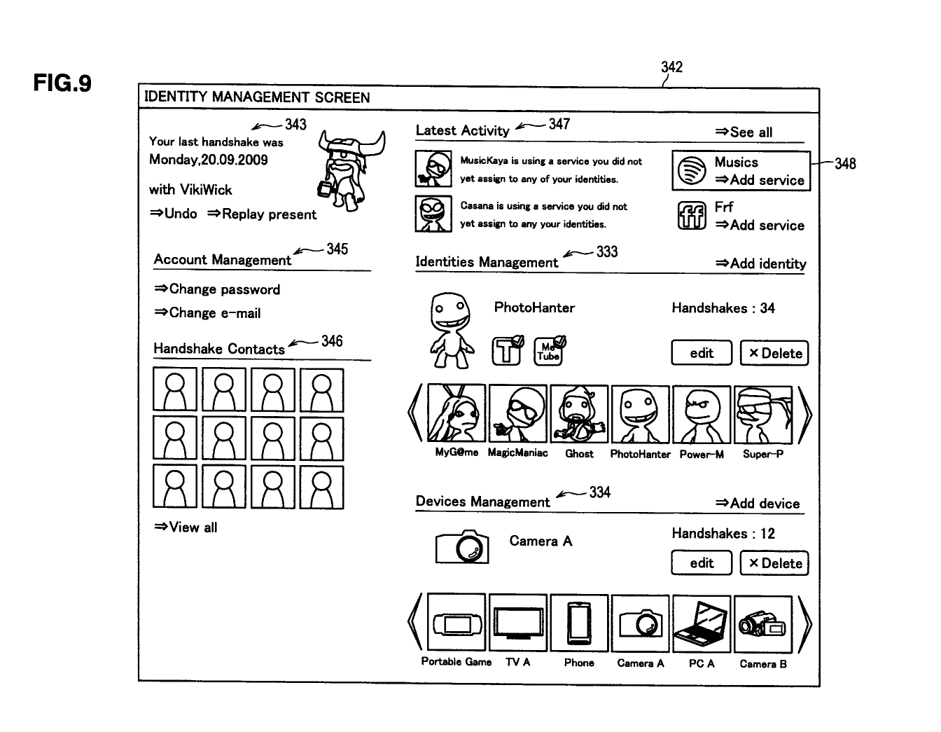

FIG. 9 is an explanatory diagram showing an identity management screen 342. The identity management screen 342 includes a latest handshake history 343, an account management field 345, a person field 346 of a handshake history, an SNS recommendation field 347, an identity management field 333, and a device management field 334.

The user can check the handshake history and check or change user registration content through the identity management screen 342. If, as a result of handshake, there is an SNS with which the other user is registered but the user is not registered, an SNS 348 is displayed in the SNS recommendation field 347 along with the identity of the other user.

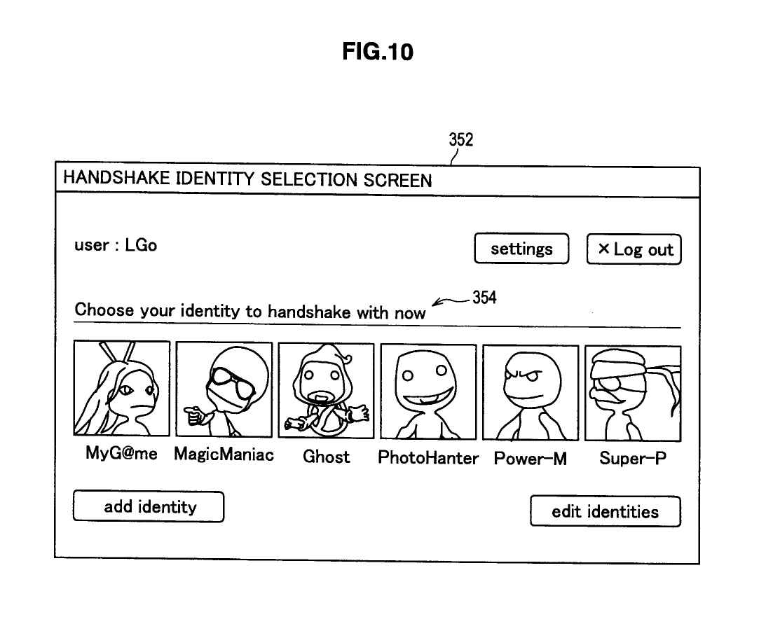

Next, the handshake in the system according to the present embodiment will be described with reference to FIGS. 10 to 19.

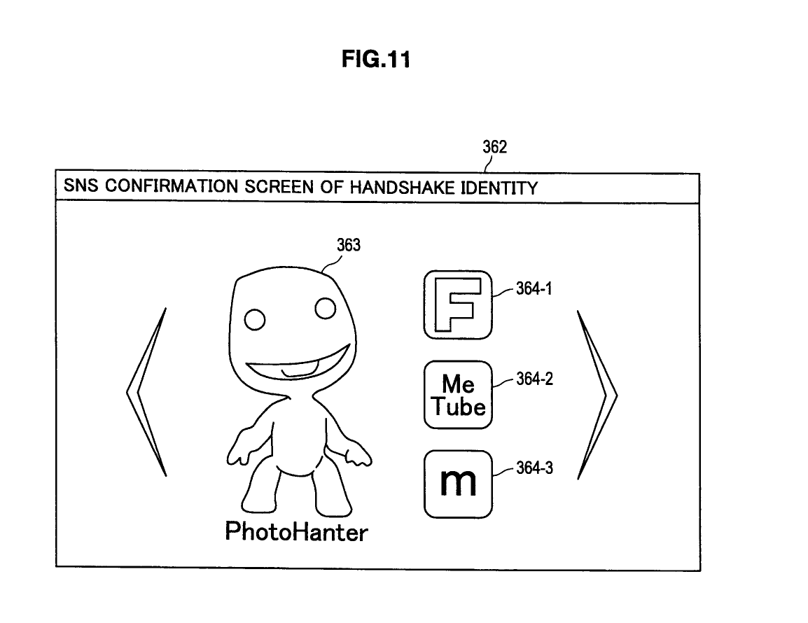

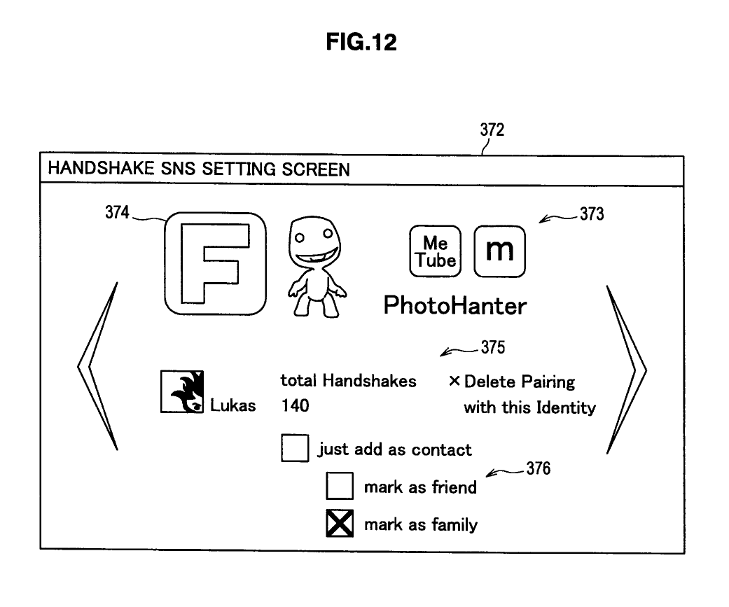

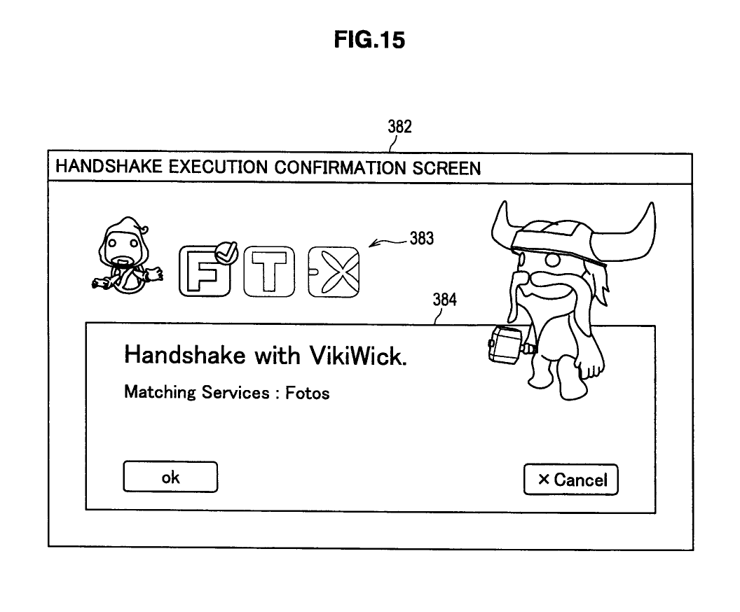

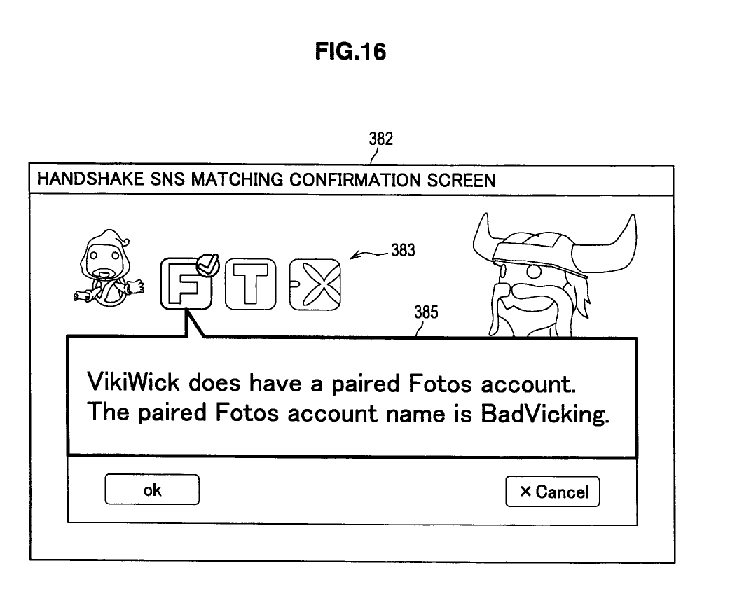

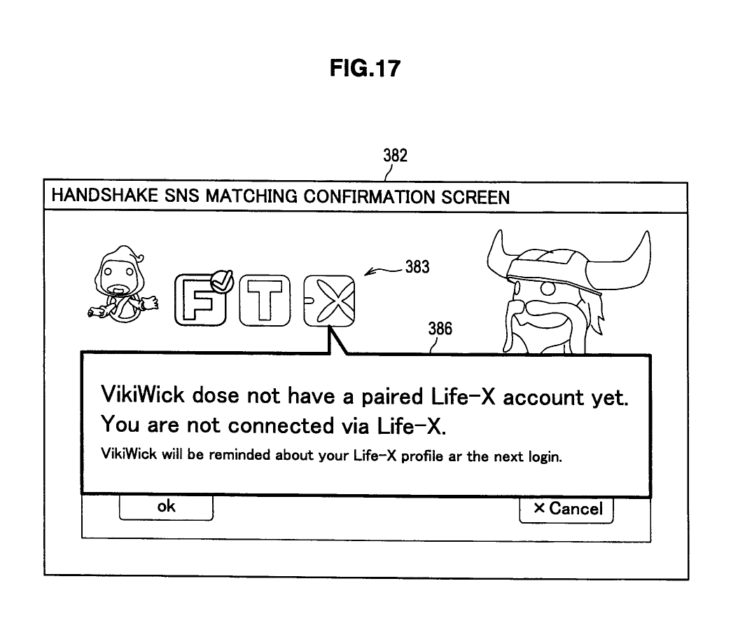

FIG. 10 is an explanatory diagram showing an identity selection screen 352 during handshake. FIGS. 11, 13, and 14 are explanatory diagrams showing an SNS confirmation screen 362 of an identity during handshake. FIG. 12 is an explanatory diagram showing an SNS setting screen 372 during handshake. FIG. 15 is an explanatory diagram showing an execution confirmation screen 382 during handshake. FIGS. 16 and 17 are explanatory diagrams showing an SNS matching confirmation screen 382 during handshake.

First, before two users bring the terminals 200 closer to cause the terminals 200 to perform proximity communication for handshake, identities caused to perform a handshake are selected by the user through the identity selection screen 352 shown in FIG. 10. The identity selection screen 352 includes an identity list 354 listing selectable identities. A plurality of avatars is displayed in the identity list 354 so that the user can select one of the avatars or edit the avatars.

If one of the avatars is selected in the identity selection screen 352, the SNS confirmation screen 362 of the identity is displayed. In the SNS confirmation screen 362 of the identity, the identity name, an avatar 363, an icon 364 indicating SNSs are displayed. The avatar 363 is used to distinguish the identity and is displayed in this case as a large avatar in the screen 362. The icon 364 indicating SNSs shows SNSs associated with the selected identity. The icon 364 is designed based on the logo of the SNS or the like. In this case, three SNSs are associated with the identity and icons 364-1, 364-2, and 364-3 are displayed in the SNS confirmation screen 362 of the identity.

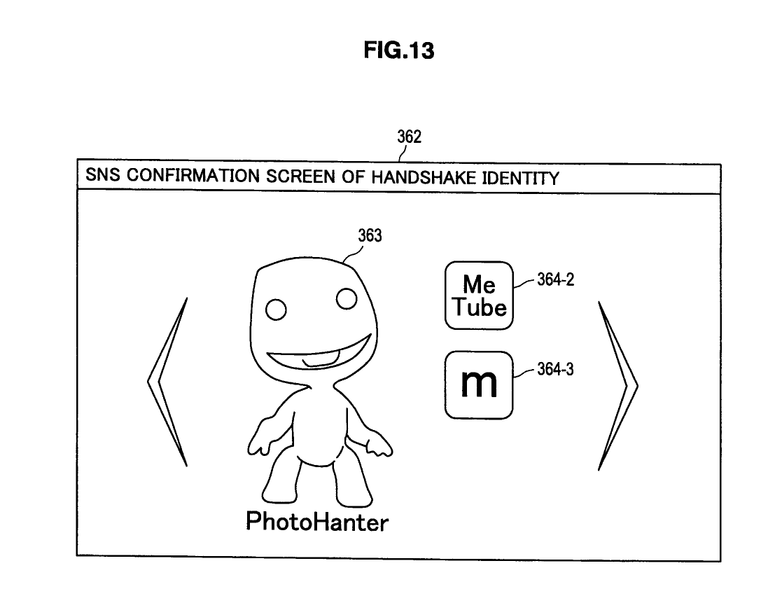

Detailed settings about the user of an SNS in the related art are made via a dedicated screen provided by the SNS server 10. In a system according to the present embodiment, SNS settings can be made by moving from the identity selection screen 352 to the SNS setting screen 372. The SNS setting screen 372 includes icons 373, 374, a handshake history 375, an SNS setting field 376 and the like. The icon 373 indicates SNSs that are associated with the identity, but are not to be set. The icon 374 indicates SNSs that are associated with the identity and to be set in the current SNS setting screen 372. By using the SNS setting screen 372, the user can make SNS settings, for example, whether to make friend registration, whether to make family registration and the like. SNSs currently associated with the identity can be excluded from the association. If an SNS is excluded from the association, the SNS confirmation screen 362 of identity shown in FIG. 11 changes to the SNS confirmation screen 362 of identity as shown in FIG. 13. In the example in FIG. 13, the icon 364-1 present in the screen in FIG. 11 is absent and the identity displayed in the SNS confirmation screen 362 shows a state in which the association with the SNS concerning the icon 364-1 is excluded.

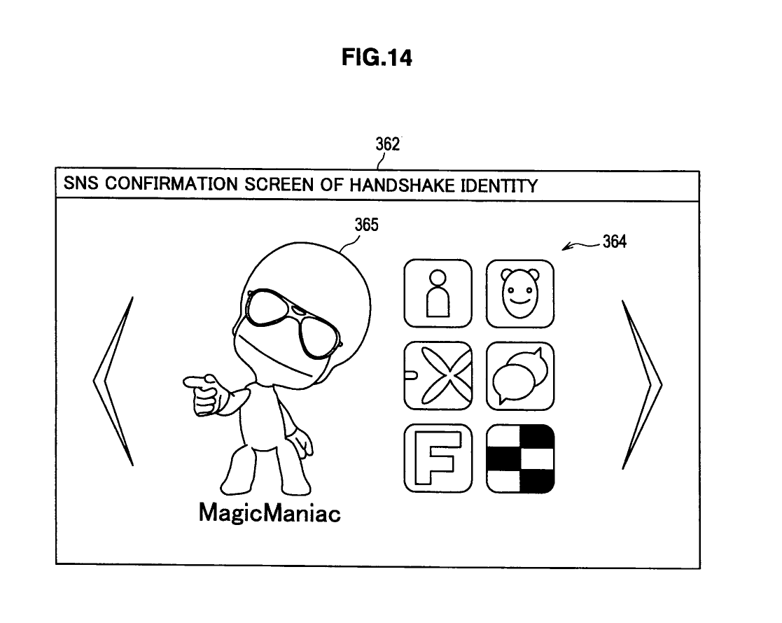

If the identity is switched in the SNS confirmation screen 362 of the identity shown in FIG. 11, the SNS confirmation screen 362 changes to the SNS confirmation screen 362 of the identity as shown in FIG. 14. In the example in FIG. 14, an identity name different from the identity name in FIG. 11, an avatar 365, and the icon 364 indicating SNSs are displayed. In this case, six SNSs are associated with the identity and the six icons 364 are displayed in the SNS confirmation screen 362.

If the identity is selected and a handshake is performed, the execution confirmation screen 382 as shown, for example, in FIG. 15 is displayed. The execution confirmation screen 382 includes the avatar indicating the identity of the user, the icon 383 indicating associated SNSs, a confirmation display 384 and the like. The confirmation display 384 displays the avatar indicating the identity set in the other terminal 200 after a handshake is performed with the other terminal 200, the identity name, and a message indicating that a handshake has been performed. The confirmation display 384 displays a message indicating that there is an SNS with which the user and the other user are registered in common. In the example in FIG. 15, a handshake has been performed with the user whose identity name is VikiWick and the SNS called Fotos is mutually matching.

If a matching SNS is present, the SNS matching confirmation screen 382 shown in FIG. 16 is displayed. The SNS matching confirmation screen 382 includes the avatar indicating the identity of the user, the icon 383 indicating associated SNSs, a confirmation display 385 and the like. The confirmation display 385 displays an SNS that is common to the user and the other user and the user name of the other user in the SNS. In the example in FIG. 16, the user whose identity name is VikiWick uses the user name of BadVicking in the SNS called Fotos.

On the other hand, when a non-matching SNS is present, the SNS matching confirmation screen 382 shown in FIG. 17 is displayed. The SNS matching confirmation screen 382 includes the avatar indicating the identity of the user, the icon 383 indicating associated SNSs, a confirmation display 386 and the like. The confirmation display 386 displays the SNS with which the other user is not registered and a message indicating that both users may not be connected via the SNS. The confirmation display 386 also displays that when the other user causes the terminal 200 to display the identity management screen 342 (for example, FIG. 9), the non-matching SNS is displayed in the SNS recommendation field 347. In the example in FIG. 17, the user whose identity name is VikiWick has no account in the SNS called Life-X.

Next, present data exchanged after a handshake will be described.

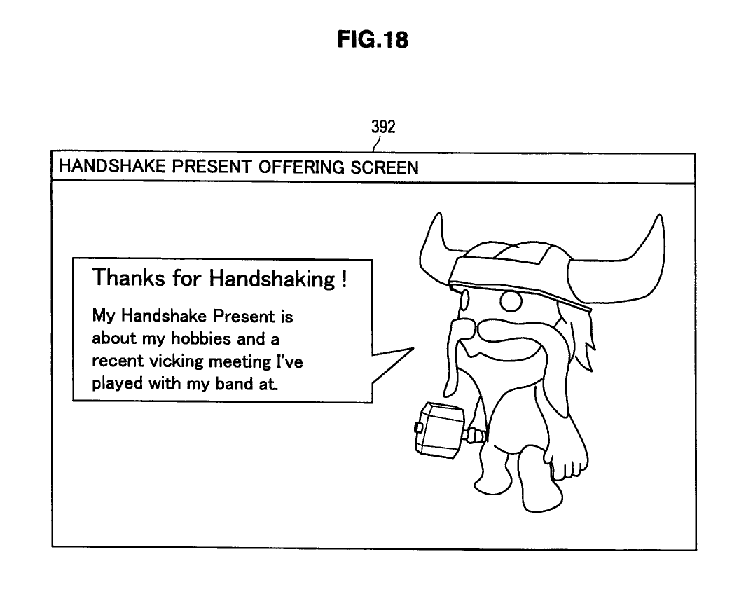

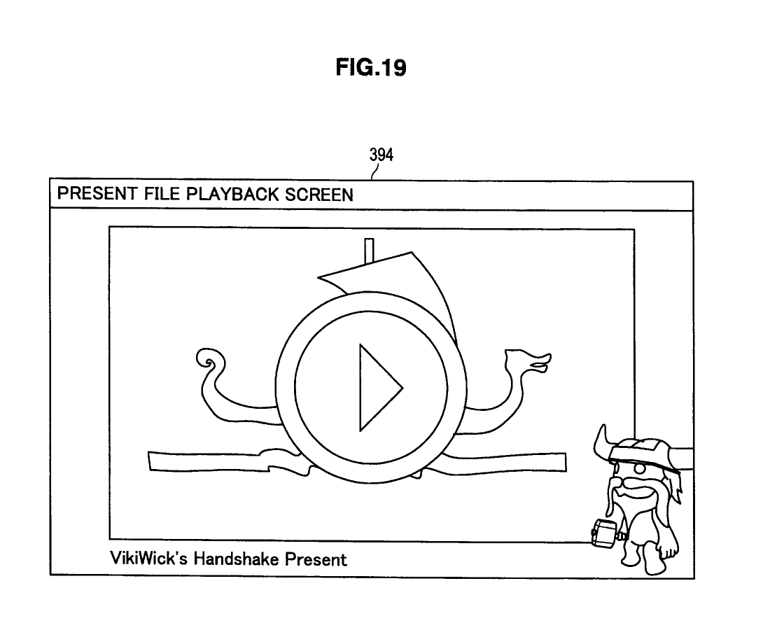

FIG. 18 is an explanatory diagram showing a present offering screen 392 after handshake. FIG. 19 is an explanatory diagram showing a playback screen 394 of a file offered as a present. All screens are displayed in the terminal 200 owned by the user and information input into one of the screens is transmitted to the management server 100.

After a handshake is performed, data such as a preset user-specific image file, sound file or the like is transmitted to the terminal 200. The present offering screen 392 shown in FIG. 18 shows user comments about present offering. The playback screen 394 of a present file shown in FIG. 19 shows how a present file provided by the other user is actually played back.

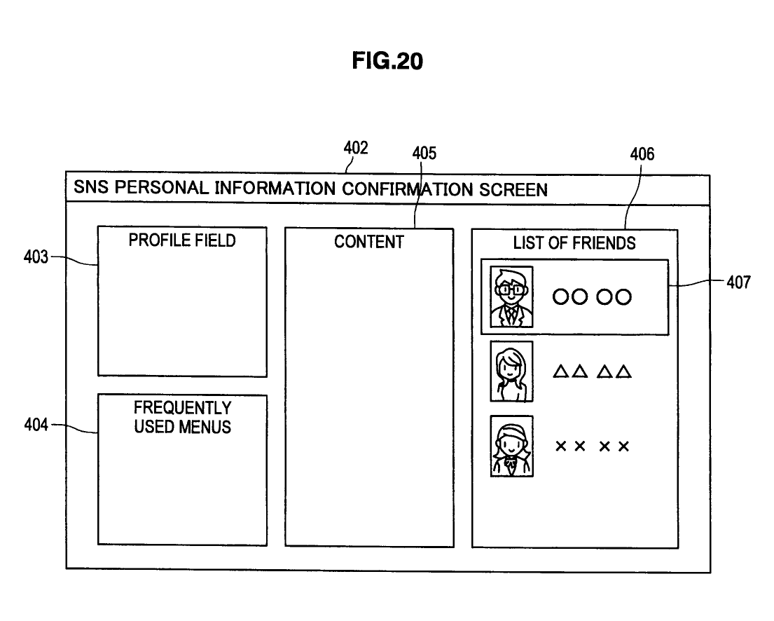

Next, processing in which a user is registered with an SNS as a friend as a result of a handshake of the terminals 200 after receiving a service of the system according to the present embodiment will be described with reference to FIG. 20. FIG. 20 is an explanatory diagram showing an SNS personal information confirmation screen 402.

In an SNS provided by each of the SNS servers 10, the user can normally cause the SNS to display the SNS personal information confirmation screen 402 as shown in FIG. 20. Registration content of the user can be checked through the screen 402. In the screen 402, for example, a profile field 403, a frequently used menu 404, content 405 provided by the SNS, and a list of friends 406 are displayed. Then, as a result of a handshake, the SNS server 10 registers the other user with whom a handshake has been performed as a friend based on information received from the management server 100 and thus, an item 407 as a new friend is added to the list 406 of the screen 402. According to the present embodiment, the user can verify that the other user with whom a handshake has been performed is added to the SNS personal information confirmation screen 402 without making a friend application to the SNS.

In the past, to add a friend to an SNS, it is necessary for the user to make a friend application by entering the user name of the other user acquired in advance via paper or mail in a screen provided by the SNS. Then, the friend registration can be completed after the other user who has received the friend application performs an approval procedure. According to the present embodiment, on the other hand, the friend registration can be completed by a handshake in which the terminals 200 are brought closer to each other without undergoing these burdensome procedures.

Based on a system according to the present embodiment, not only can the friend registration be completely smoothly, but also the friend registration of the SNS in accordance with business scenes, private scenes, or home use can be completed by handshake via the identity. For example, by performing a handshake of the terminal 200 with the terminal 200 such as a TV in the home of a grandmother by switching to the identity for home use, an SNS to be shared with the grandmother can easily be provided. As a result, even the grandmother who is not familiar with the SNS can acquire photos and the like from the user and the user can provide photos and the like to the grandmother via the SNS.

Also by performing a handshake of the terminal 200 with the terminal 200 owned by a customer or colleague by switching to the business identity, an SNS necessary for business can be shared with the customer or colleague. The friend registration is completed without accessing a management screen of the SNS and therefore, information provided by the other user via the SNS can immediately be acquired and information useful for the other user can immediately be provided after a handshake.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2010-139936 filed in the Japan Patent Office on Jun. 18, 2010, the entire content of which is hereby incorporated by reference.

What is claimed is:

1. An information processing apparatus, comprising:
a receiving unit that receives information about one or a plurality of applications from each of a first terminal apparatus associated with a first user and a second terminal apparatus associated with a second user and receives a message indicating that mutual communication has been performed from the first terminal apparatus and the second terminal apparatus after the first terminal apparatus and the second terminal apparatus mutually communicate;
a judgment unit that, upon receiving the message indicating that the first terminal apparatus and the second terminal apparatus have mutually communicated, judges whether there is any common application between the one or the plurality of applications associated with the first terminal apparatus and the one or the plurality of applications associated with the second terminal apparatus; and
a first transmitting unit that, when the common application is present, transmits the message indicating that the first user and the second user make friend registration with the common application to one or a plurality of corresponding application server apparatuses.

2. The information processing apparatus according to claim 1,
wherein when the judgment unit judges that the application that is not common is present, the first transmitting unit transmits information about the application that is not common to the first terminal apparatus or the second terminal apparatus that is not associated with the application that is not common.

3. The information processing apparatus according to claim 1,
wherein the information about the one or the plurality of applications received from the first terminal apparatus is associated with first virtual subject information associated with the first terminal apparatus and the information about the one or the plurality of applications received from the second terminal apparatus is associated with second virtual subject information associated with the second terminal apparatus, and
the judgment unit judges whether there is any common application between the one or the plurality of applications associated with the first virtual subject information and the one or the plurality of applications associated with the second virtual subject information.

4. The information processing apparatus according to claim 1, further comprising:
a second transmitting unit that, upon receiving the message indicating that the first terminal apparatus and the second terminal apparatus have mutually communicated, transmits data registered by the first user in advance to the second terminal apparatus.

5. The information processing apparatus according to claim 1,
wherein the application is a social networking service.

6. An information processing method, comprising:
receiving information about one or a plurality of applications from each of a first terminal apparatus associated with a first user and a second terminal apparatus associated with a second user and receiving a message indicating that mutual communication has been performed from the first terminal apparatus and the second terminal apparatus after the first terminal apparatus and the second terminal apparatus mutually communicate;
upon receiving the message indicating that the first terminal apparatus and the second terminal apparatus have mutually communicated, judging whether there is any common application between the one or the plurality of applications associated with the first terminal apparatus and the one or the plurality of applications associated with the second terminal apparatus; and
when the common application is present, transmitting the message indicating that the first user and the second user make friend registration with the common application to one or a plurality of corresponding application server apparatuses.

7. A program causing a computer to execute:
receiving information about one or a plurality of applications from each of a first terminal apparatus associated with a first user and a second terminal apparatus associated with a second user and receiving a message indicating that mutual communication has been performed from the first terminal apparatus and the second terminal apparatus after the first terminal apparatus and the second terminal apparatus mutually communicate;
upon receiving the message indicating that the first terminal apparatus and the second terminal apparatus have mutually communicated, judging whether there is any common application between the one or the plurality of applications associated with the first terminal apparatus and the one or the plurality of applications associated with the second terminal apparatus; and
when the common application is present, transmitting the message indicating that the first user and the second user make friend registration with the common application to one or a plurality of corresponding application server apparatuses.
